(19) United States
(12) Patent Application Publication
(10) Pub. No.: US 2026/0319265 A1
(43) Pub. Date: Oct. 15, 2026

(54) AUTOMATIC ASSEMBLY SYSTEM OF OPTICAL ASSEMBLY FOR HIGH-SPEED OPTICAL MODULE

(71) Applicant: ACCELIGHT TECHNOLOGIES (WUHAN) CO., LTD., Wuhan (CN)

(72) Inventors: GONG-EN GU, Pleasanton, CA (US); MICHAEL XIAOYAN WEI, Pleasanton, CA (US); William Sterling, Pleasanton, CA (US); Meirong ZHANG, Wuhan (CN)

(73) Assignee: ACCELIGHT TECHNOLOGIES (WUHAN) CO., LTD., Wuhan (CN)

(21) Appl. No.: 19/464,044

(22) Filed: Jan. 29, 2026

(30) Foreign Application Priority Data
Aug. 20, 2025 (CN) 202511167186.4

(51) Int. Cl. G02B 27/62; G02B 6/293

(52) U.S. Cl. CPC G02B 27/62; G02B 6/2938

(57) ABSTRACT

An automatic assembly system of an optical assembly for a high-speed optical module, includes: an irradiation curing unit, a floating pressure plate, a first positioning plate with a first profiled groove for limiting a filter, a second positioning plate with a second profiled groove for fixing a wavelength division multiplexing (WDM) component base and a steering prism, a glass pressure block arranged on the floating pressure plate. The glass pressure block, the first profiled groove, and the second profiled groove are correspondingly arranged. Under displacement of the floating pressure plate, the filter located in the first profiled groove is loaded onto the glass pressure block and then bonded to the WDM component base located in the second profiled groove.

### CROSS-REFERENCE TO RELATED APPLICATIONS

This application claims priority to the Chinese patent application No. 202511167186.4, filed on Aug. 20, 2025. The entire content of the Chinese patent application is incorporated herein by reference.

### TECHNICAL FIELD

The present disclosure relates to the technical field of optical modules, and in particular, to an automatic assembly system of an optical assembly for a high-speed optical module.

### BACKGROUND

With the rapid development and large-scale application of new services such as cloud computing, big data, and artificial intelligence, the demand for computing power has been continuously increasing. This has led to extensive construction of data centers and supercomputing centers, which in turn has driven the continuous expansion of the high-speed optical module market. Correspondingly, the demand for various optical devices and components used in high-speed optical modules is also growing steadily.

As one of the key components in high-speed optical modules, the wavelength division multiplexers have increasing demand year by year. The wavelength division multiplexer typically includes key components such as a steering prism, a wavelength division multiplexing (WDM) component base, and a filter. In conventional assembly processes, the WDM component base and steering prism are typically bonded first, followed by the sequential bonding of the filters.

In the prior art, the process of bonding the filters has the following drawbacks: 1. A fixture and a probe are used to attach the filters one by one. This approach only allows for dispensing, positioning, and curing of a single thin-film filter of one WDM component at a time, resulting in cumbersome operation and low production efficiency. 2. when attaching the filters individually with the fixture and the probe, as pressure is applied from the top by the probe or the fixture, ultraviolet (UV) curing can only be irradiated from the sides, which causes uneven distribution of energy reaching the adhesive, posing a risk of curing failure.

Therefore, there is an urgent need for an improved automatic assembly system of an optical assembly for a high-speed optical module, enhancing assembly efficiency, and ensuring adhesive curing quality, thereby meeting the growing market demand for high-speed optical modules.

### SUMMARY OF PRESENT INVENTION

The technical problem to be solved by the present disclosure is to, for the technical defects in the prior art, provide an automatic assembly system of an optical assembly for a high-speed optical module. This system not only offers the advantages of miniaturization and ease of assembly but also ensures that filters on all WDM components are bonded on the same plane, guaranteeing consistency in batch production.

The present disclosure solves the technical problems with the following technical solution: the present disclosure discloses an automatic assembly system of an optical assembly for a high-speed optical module, including: an irradiation curing unit; a floating pressure plate; a first positioning plate with a first profiled groove defined thereon, wherein the optical assembly comprises a filter, a wavelength division multiplexing (WDM) component base, and a steering prism, and the first profiled groove is configured to limit the filter; a second positioning plate with a second profiled groove defined thereon for fixing the WDM component base and the steering prism; wherein the floating pressure plate, the first positioning plate and the second positioning plate are sequentially arranged below the irradiation curing unit; a glass pressure block arranged on the floating pressure plate, wherein the glass pressure block, the first profiled groove, and the second profiled groove are correspondingly arranged; the glass pressure block is configured to apply pressure onto the filter located in the first profiled groove under movement of the floating pressure plate, and hence the filter is bonded to the WDM component base located in the second profiled groove.

In one preferred embodiment of the present disclosure, the automatic assembly system of an optical assembly for a high-speed optical module further includes a hollow base, the second positioning plate is fixedly connected to a top end of the hollow base, the first positioning plate is fixedly connected to the second positioning plate, a plurality of second profiled grooves are formed, locking push rods arranged perpendicular to the second profiled grooves are provided on the hollow base, and the locking push rods and the second profiled grooves are arranged in one-to-one correspondence.

In one preferred embodiment of the present disclosure, a lifting drive unit is arranged on the hollow base, and the drive unit is connected to the floating pressure plate.

In one preferred embodiment of the present disclosure, the drive unit includes a vertical guide slot defined on the hollow base and a slider slidably fitted and inserted into the vertical guide slot; an end of the slider is provided with the floating pressure plate; a spring is arranged between the slider and the second positioning plate; and an ejector pin assembly arranged below the slider for driving the slider to move is.

In one preferred embodiment of the present disclosure, the ejector pin assembly includes a mounting base; the mounting base is provided with a micrometer, a rocker, and a guide hole; the rocker is rotatably connected to the mounting base through a pin; an ejector pin is inserted into the guide hole; and the rocker has one end in contact with the micrometer and another end in contact with the ejector pin.

In one preferred embodiment of the present disclosure, the slider is of a U-shaped structure, a spring positioning block is connected to the slider, and a spring fixing slot is formed on the spring positioning block.

In one preferred embodiment of the present disclosure, slider avoiding slots are formed on the first positioning plate and the second positioning plate, respectively.

In one preferred embodiment of the present disclosure, each of the second profiled grooves corresponds to at least one first profiled groove.

In one preferred embodiment of the present disclosure, the irradiation curing unit includes a positioning bottom plate, a positioning side plate connected to the positioning bottom plate, a positioning cross bar which is vertically movable connected to the positioning side plate, and an irradiation member arranged on the positioning cross bar.

In one preferred embodiment of the present disclosure, the irradiation member is a UV curing lamp.

The beneficial effects of the present disclosure are as follows: the automatic assembly system of an optical assembly for a high-speed optical module disclosed in the present disclosure effectively solves the problems in the prior art of low assembly efficiency and unstable adhesive curing quality of WDM components through a specific structural design. The device includes the irradiation curing unit, below which the floating pressure plate, the first positioning plate, and the second positioning plate are sequentially arranged. Corresponding arrangement of the glass pressure blocks, the first profiled grooves, and the second profiled grooves realizes synchronous and precise bonding of the steering prisms and the WDM component bases, not only remarkably improving the assembly efficiency of the WDM components, but also ensuring the adhesive curing quality and the product consistency, and providing powerful support for large-scale production of high-speed optical modules.

The present disclosure first employs the transparent glass pressure blocks to uniformly press and secure the filters after adhesive dispensing, achieving even pressure distribution on the steering prisms, ensuring that the filters on all the WDM components lie in the same plane, and guaranteeing the consistency in batch production.

Furthermore, the transparent glass pressure blocks in the present disclosure do not cause obstruction during UV curing, allowing UV light to directly irradiate the adhesive. This results in more uniform curing energy distribution, enhances the product consistency, and solves the problem of uneven energy distribution caused by side irradiation in the prior art.

Moreover, through the coordinated operation of components such as the hollow base, the locking push rods, and drive unit, the present disclosure enables batch assembly of the WDM components. The design of the vertical guide slot, the slider, and the springs in the drive unit guarantees precise pressure control. The arrangement of the ejector pin assembly provides a fine adjustment capability, further improving the assembly precision. In addition, the design of a plurality of first profiled grooves corresponding to one second profiled groove allows synchronous assembly of a plurality of WDM components, greatly improving the production efficiency.

At last, the compact design of the overall fixture allows for handheld operation under a microscope, significantly enhancing the assembly convenience and flexibility, thereby markedly improving the production efficiency. This feature offers a distinct advantage over the prior art that requires fixing the entire device onto a vibration-isolation platform.

### BRIEF DESCRIPTION OF THE DRAWINGS

The present disclosure is described in further detail with reference to the accompanying drawings and embodiments. In the accompanying drawings:

FIG. 1 is a schematic structural diagram showing an automatic assembly system of an optical assembly for a high-speed optical module according to the present disclosure;

FIG. 2 is a sectional view showing an automatic assembly system of a optical assembly for a high-speed optical module according to the present disclosure;

FIG. 3 is a schematic structural diagram showing a second positioning plate of an automatic assembly system of an optical assembly for a high-speed optical module according to the present disclosure;

FIG. 4 is a schematic structural diagram showing a first positioning plate of an automatic assembly system of an optical assembly for a high-speed optical module according to the present disclosure;

FIG. 5 is a top view showing a first positioning plate of an automatic assembly system of an optical assembly for a high-speed optical module according to the present disclosure;

FIG. 6 is a schematic structural diagram showing a drive unit of an automatic assembly system of an optical assembly for a high-speed optical module according to the present disclosure;

FIG. 7 is a schematic structural diagram showing an irradiation curing unit of an automatic assembly system of an optical assembly for a high-speed optical module according to the present disclosure; and

FIG. 8 is a schematic structural diagram showing a WDM component of an automatic assembly system of an optical assembly for a high-speed optical module according to the present disclosure.

In the drawings: 1- UV curing lamp, 2- positioning cross bar, 3- positioning side plate, 4- positioning bottom plate, 5- floating pressure plate, 6- glass pressure block, 7- locking push rod, 8- second positioning plate, 8-1- second profiled groove, 8-2- slider avoiding slot, 9- slider, 10- hollow base, 10-1- vertical guide slot, 11- micrometer, 12- rocker, 13- connecting plate, 14- mounting base, 15- guide slot, 16- WDM component, 16-1- steering prism, 16-2- WDM component base, 16-3- filter, 17- first positioning plate, 17-1- first profiled groove, 17-2- slider avoiding slot, 18- mounting side plate, 19- ejector pin, 20- spring positioning block, 21- spring

### DETAILED DESCRIPTION OF THE EMBODIMENTS

In order to make the objectives, technical solutions, and advantages of the present disclosure more clear, the present disclosure is further described in detail below with reference to the accompanying drawings and embodiments. It should be understood that the specific embodiments described herein are intended merely to explain the present disclosure, rather than to limit the present disclosure.

### Embodiment 1

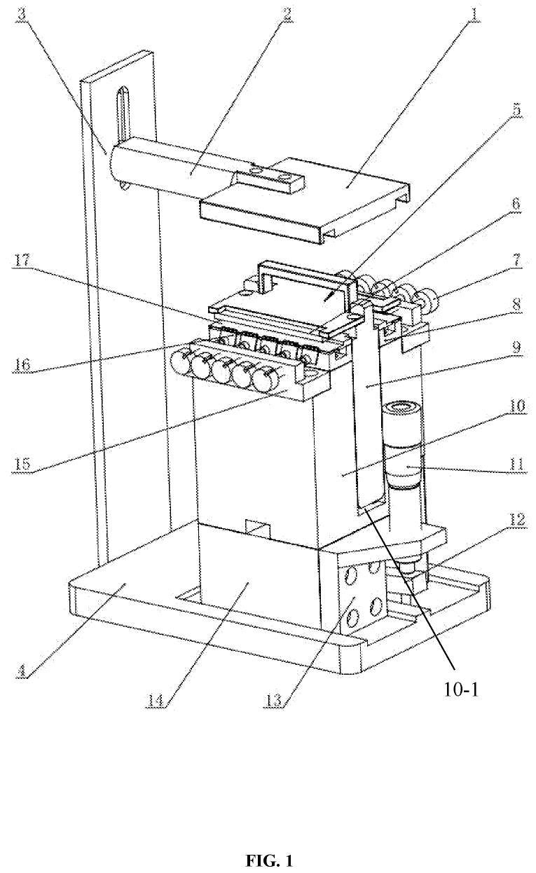

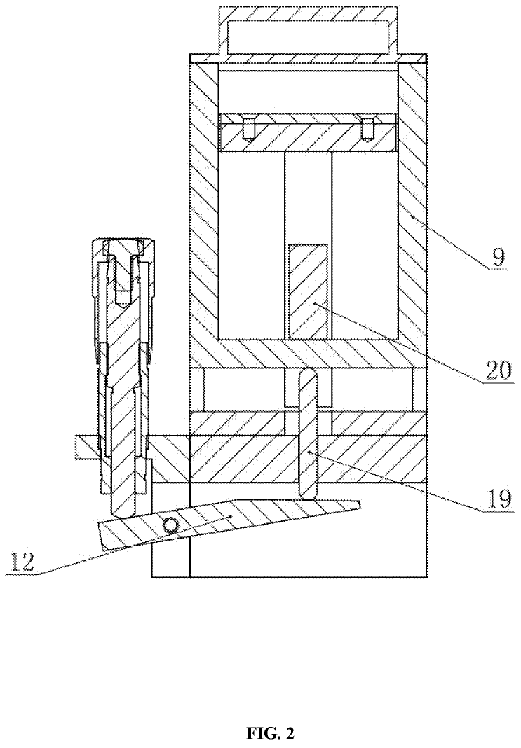

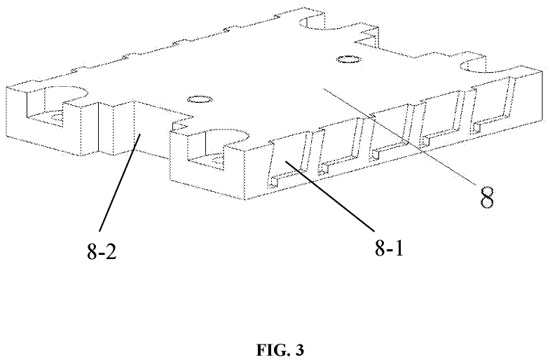

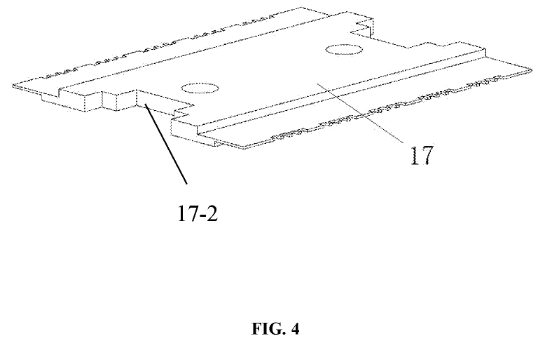

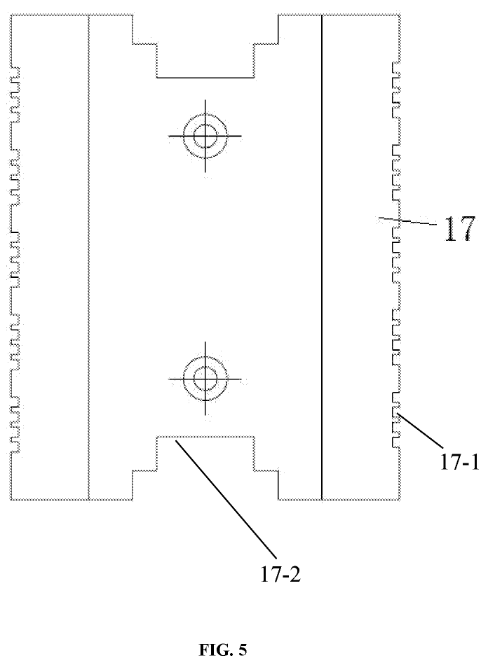

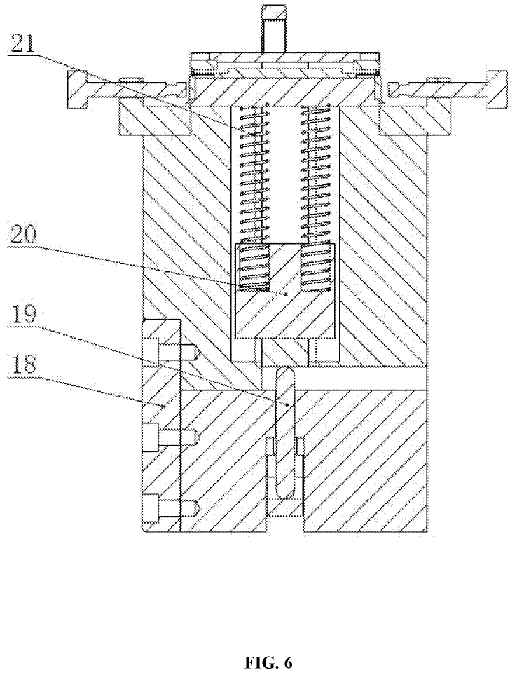

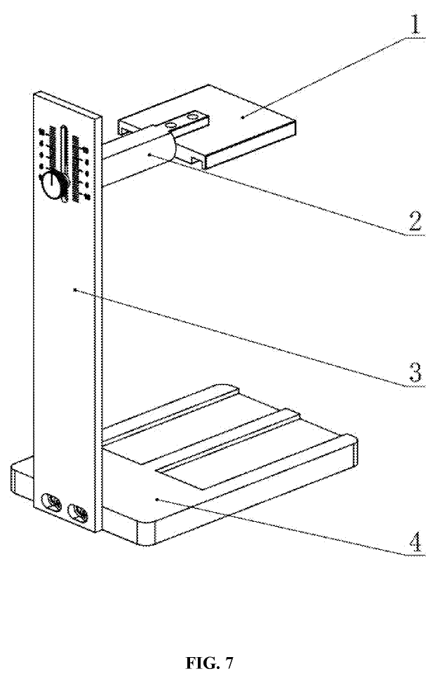

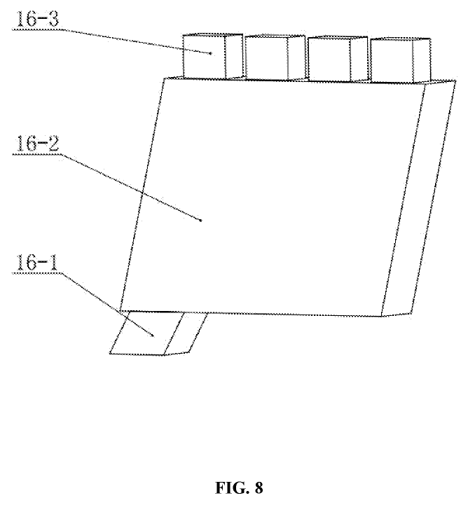

Referring to FIG. 1 to FIG. 8, this embodiment provides an automatic assembly system of an optical assembly for a high-speed optical module, which is configured to implement a bonding procedure between filters 16-3 and WDM component bases 16-2 on WDM components 16. The device mainly includes an irradiation curing unit, a floating pressure plate 5, a first positioning plate 17, a second positioning plate 8, and other key components. Through precise mechanical design and coordinated operation, the problems in the prior art of low assembly efficiency and unstable adhesive curing quality of the WDM components are solved.

The overall structure of this batch assembly device includes: the irradiation curing unit positioned at the topmost level, with the floating pressure plate 5, the first positioning plate 17, and the second positioning plate 8 arranged sequentially below it. The first positioning plate 17 is provided with first profiled grooves 17-1 for limiting the filters 16-3 of the WDM components, and the profiled grooves are precisely designed according to the shape of the filters, ensuring that the filters can be accurately positioned. The second positioning plate 8 is provided with second profiled grooves 8-1 that are configured to fix the WDM component bases 16-2 and steering prisms 16-1 of the WDM components, and the profiled grooves precisely match the WDM component bases and the steering prisms in shape, ensuring that the components cannot displace during assembly. Glass pressure blocks 6 are provided on the floating pressure plate 5, and the glass pressure blocks are made of a transparent material, with excellent optical transmittance. The glass pressure blocks 6, the first profiled grooves 17-1, and the second profiled grooves 8-1 are correspondingly arranged, ensuring that under displacement of the floating pressure plate 5, the glass pressure blocks 6 can accurately apply pressure onto the filters 16-3 located in the first profiled grooves 17-1, thereby precisely bonding the filters 16-3 to the WDM component bases 16-2 located in the second profiled grooves 8-1.

The device further includes a hollow base 10, the second positioning plate 8 is fixedly connected to a top end of the hollow base 10, and the first positioning plate 17 is fixedly connected above the second positioning plate 8. A plurality of guide slots 15 are defined on the hollow base 10, and each guide slot 15 is arranged perpendicular to the second profiled grooves 8-1, ensuring the precision of locking actions. Each guide slot 15 is provided with a locking push rod 7, and the locking push rods 7 and the second profiled grooves 8-1 are arranged in one-to-one correspondence. This design can ensure that each WDM component base can be stably locked in the corresponding second profiled groove 8-1, preventing displacement during assembly.

The drive unit is one of the key parts of the device, is arranged on the hollow base 10, has lifting characteristics, and is connected to the floating pressure plate 5. The drive unit includes a vertical guide slot 10-1 defined on the hollow base 10 and a slider 9 slidably fitted and inserted into the vertical guide slot 10-1. An end of the slider 9 is provided with the floating pressure plate 5, and springs 21 are provided between the slider 9 and the second positioning plate 8. This design enables the floating pressure plate 5 to flexibly move in a vertical direction, and springs 21 can provide appropriate pressure. An ejector pin assembly for driving the slider 9 to move is provided below the slider 9, and the ejector pin assembly can realize precise control of the floating pressure plate 5.

The ejector pin assembly includes a mounting base 14, and the mounting base 14 and the hollow base 10 are connected through a mounting side plate 18 to form a stable support structure. A micrometer 11, a rocker 12, and a guide hole are provided on the mounting base 14 through a connecting plate 13. The rocker 12 is rotatably connected to the mounting base 14 through a pin, and an ejector pin 19 is inserted into the guide hole. The rocker 12 has one end in contact with the micrometer 11 and another end in contact with the ejector pin 19. This lever mechanism can convert fine rotation of the micrometer 11 into precise displacement of the ejector pin 19, realizing precise control of the floating pressure plate 5.

The slider 9 is of a U-shaped structure, which has excellent stability and guide performance. A spring positioning block 20 is connected to the slider 9, and spring fixing slots are formed on the spring positioning block 20 for fixing the springs 21, ensuring that the springs 21 cannot deviate during compression and release. Slider avoiding slots 17-2 and 8-2 are respectively formed on the first positioning plate 17 and the second positioning plate 8, and this design ensures that the slider 9 cannot interfere with other components during movement.

One important feature of this device is that each of the second profiled grooves 8-1 corresponds to at least one of the first profiled grooves 17-1, and this one-to-more design enables this device to realize batch assembly of the WDM components, thereby greatly improving the production efficiency.

The irradiation curing unit is another core part of this device. The irradiation curing unit includes a positioning bottom plate 4, a positioning side plate 3 is connected to the positioning bottom plate 4, a positioning cross bar 2 which is vertically movable is connected to the positioning side plate 3, and a UV curing lamp 1 is provided on the positioning cross bar 2. The positioning side plate 3 has scales for adjusting the position of the positioning cross bar 2 to adjust a distance between the UV curing lamp 1 and an assembly platform, thereby adjusting the light power of UV irradiation. This design allows precise adjustment of the UV curing process according to different adhesive types and curing requirements, ensuring the consistency and stability of the curing effect.

A method for using this device is as follows: first, the micrometer 11 is rotated to press down the rocker 12, the rocker 12 ejects up the ejector pin 19, and the ejector pin 19 ejects up the slider 9. The glass pressure blocks 6 and the floating pressure plate 5 are bonded together and fixed to the slider 9, and as the slider 9 rises, a space is formed to assemble the WDM components. Meanwhile, the slider 9 ejects up the spring fixing slots, and two springs 21 in the spring fixing slots are compressed, whereby the spring fixing slots and the ejector pin 19 together fix the slider 9 to create stable conditions for subsequent assembly operations.

### Embodiment 2

This embodiment provides a specific operation process and application method for the automatic assembly system of an optical assembly for a high-speed optical module. On the basis of Embodiment 1, this device focuses on detailing its actual operation process, the synergistic interaction among its components, and its application effects in practical production.

During actual application, operators first need to prepare the device and related components. The device is placed on a stable operation tabletop, ensuring its levelness and stability. The micrometer 11 is rotated to press down the rocker 12, the rocker 12 ejects up the ejector pin 19 on the basis of the lever principle, and the ejector pin 19 ejects up the slider 9. Because the glass pressure blocks 6 and the floating pressure plate 5 are bonded and fixed to the slider 9, the entire upper structure is lifted as the slider 9 rises, thereby providing sufficient operational space for the placement of the WDM components.

Meanwhile, the slider 9 ejects up the spring fixing slots during upward movement, and two springs 21 in the spring fixing slots are compressed accordingly. The springs 21 in a compressed state and the ejector pin 19 together stably fix the slider 9 at a rise position, providing a stable operation environment for subsequent precise operations. This design ingeniously utilizes mechanical principles, avoiding complex electrical control systems and making the device simpler and more reliable.

After completing the preparations, operators need to carefully place the WDM component bases 16-2, with the steering prisms 16-1 already bonded to them, into the second profiled grooves 8-1 of the second positioning plate 8. The second profiled grooves 8-1 precisely match the WDM component bases 16-2 and the steering prisms 16-1 in shape, ensuring that the components are accurately positioned. After the placement is complete, the locking push rods 7 are rotated to firmly fix the WDM component bases 16-2 into the second profiled grooves 8-1, preventing displacement in the subsequent operation process.

Next, the operators need to perform adhesive dispensing according to gaps on the first positioning plate 17. The adhesive dispensing operation needs to precisely control the amount and position of adhesive, thus guaranteeing a good bonding effect. After the adhesive dispensing is finished, the filters 16-3 are sequentially placed into the first profiled grooves 17-1 of the first positioning plate 17 according to a wavelength order. This method for placement according to the wavelength order ensures normal functions of the finally assembled WDM components, thereby achieving an expected wavelength separation effect.

After the filters have been placed on two sides of the WDM components, the operators need to rotate the micrometer 11 to lower the rocker 12. As the rocker 12 lowers, the compressed springs 21 start to release elastic force, to push the slider 9 and the ejector pin 19 to lower together. This process will proceed until the glass pressure blocks 6 and the floating pressure plate 5 on the slider 9 are pressed down to the surfaces of the filters.

The smooth surface design of the glass pressure blocks 6 is one key feature of this device. When the glass pressure blocks 6 are lowered in place, the filters 16-3 on two sides of WDM components are uniformly pressed to the same plane, ensuring that all the filters have the same flatness and adhesive layers have the same thickness. This consistency is more important to the optical performance of the WDM components, directly affecting the quality and reliability of a final product. In this state, the elastic force of the springs 21 lasts acting, whereby the glass pressure blocks 6 firmly press the filters 16-3 on the WDM component bases 16-2 to form stable pressure, creating ideal conditions for adhesive curing.

The components are fixed on the assembly platform, followed by ultraviolet curing. The operators need to precisely place the whole assembly platform on a UV curing platform through slide grooves. Guide rails are designed on the positioning bottom plate 4 of the UV curing platform and perfectly match the bottom of the assembly platform, ensuring that the position of the component assembly platform on the curing platform each time is fixed, which is critical to the consistency in batch production.

The scale design on the positioning side plate 3 allows the operators to precisely adjust the position of the positioning cross bar 2, thereby adjusting the distance between the UV curing lamp 1 and the assembly platform. This adjustability allows for flexible adjustment of the light power of UV irradiation based on different types of adhesives and curing requirements, thereby optimizing the curing effect.

Another outstanding advantage of this device is that the glass pressure blocks 6 are made of a transparent material. This design enables the UV curing lamp 1 to irradiate uniformly from above, with UV light passing directly through the transparent glass pressure blocks 6 onto the adhesive, ensuring consistent exposure power for the filters on all the WDM components, and significantly improving the curing uniformity. Compared to conventional methods that only allow for side irradiation, this method offers distinct advantages and effectively solves the curing quality problems caused by uneven energy distribution.

After a certain period of UV irradiation, the adhesive will fully cured, securely bonding the filters 16-3 to the WDM component bases 16-2. Meanwhile, the operators can rotate the micrometer 11 to lift the glass pressure blocks 6 again, then release the lock of the locking push rods 7 and carefully remove the fully assembled WDM components. This device can process a plurality of WDM components at the same time, greatly improving the production efficiency, and is an ideal batch production tool.

The overall design of this device is compact, lightweight, and suitable for handheld operation, allowing for precise assembly operations under a microscope. This significantly enhances operational flexibility and convenience. Meanwhile, by adopting mechanical transmission principles, this device avoids the need for complex electrical control systems, thereby reducing the device complexity and failure rate while enhancing the production reliability and stability.

It should be understood that the serial number of each step in the above embodiment does not indicate the order of performing the process. The order of performing each process is determined by its function and internal logic, and should not limit the implementation of the embodiments of the present disclosure.

It should be understood that those of ordinary skill in the art can make improvements or transformations based on the above description, and all these improvements and transformations should fall within the protection scope of the appended claims of the present disclosure.

What is claimed is:

1. An automatic assembly system of an optical assembly for a high-speed optical module, comprising:
an irradiation curing unit;
a floating pressure plate;
a first positioning plate with a first profiled groove defined thereon, wherein the optical assembly comprises a filter, a wavelength division multiplexing (WDM) component base, and a steering prism, and the first profiled groove is configured to limit the filter;
a second positioning plate with a second profiled groove defined thereon for fixing the WDM component base and the steering prism; wherein the floating pressure plate, the first positioning plate and the second positioning plate are sequentially arranged below the irradiation curing unit;
a glass pressure block arranged on the floating pressure plate, wherein the glass pressure block, the first profiled groove, and the second profiled groove are correspondingly arranged; the glass pressure block is configured to apply pressure onto the filter located in the first profiled groove under movement of the floating pressure plate, and hence the filter is bonded to the WDM component base located in the second profiled groove;
a hollow base;
a lifting drive unit arranged on the hollow base, wherein the drive unit comprises a vertical guide slot defined on the hollow base and a slider slidably fitted and inserted into the vertical guide slot; an end of the slider is provided with the floating pressure plate;
a spring arranged between the slider and the second positioning plate; and
an ejector pin assembly arranged below the slider for driving the slider to move.

2. The automatic assembly system according to claim 1, wherein the second positioning plate is fixedly connected to a top end of the hollow base and the first positioning plate is fixedly connected to the second positioning plate, a plurality of second profiled grooves are formed, locking push rods arranged perpendicular to the plurality of second profiled grooves are provided on the hollow base, and the locking push rods and the plurality of second profiled grooves are arranged in one-to-one correspondence.

3. The automatic assembly system according to claim 1, wherein the ejector pin assembly comprises a mounting base; the mounting base is provided with a micrometer, a rocker, and a guide hole; the rocker is rotatably connected to the mounting base through a pin; an ejector pin is inserted into the guide hole; and the rocker has one end in contact with the micrometer and another end in contact with the ejector pin.

4. The automatic assembly system according to claim 1, wherein the slider is of a U-shaped structure, a spring positioning block is connected to the slider, and a spring fixing slot is formed on the spring positioning block.

5. The automatic assembly system according to claim 4, wherein slider avoiding slots are formed on the first positioning plate and the second positioning plate, respectively.

6. The automatic assembly system according to claim 1, wherein a plurality of second profiled grooves are formed, and each of the plurality of second profiled grooves corresponds to at least one first profiled groove.

7. The automatic assembly system according to claim 1, wherein the irradiation curing unit comprises a positioning bottom plate, a positioning side plate connected to the positioning bottom plate, a positioning cross bar which is vertically movable connected to the positioning side plate, and an irradiation member arranged on the positioning cross bar.

8. The automatic assembly system according to claim 7, wherein the irradiation member is an ultraviolet (UV) curing lamp.
